(19) United States
(12) Patent Application Publication
(10) Pub. No.: US 2020/0302824 A1
(43) Pub. Date: Sep. 24, 2020

(54) SEVEN STEPS LEARNING STUDY BOOK OF RUAH EDUCATION AND RUAH LEARNING METHOD USING THEREOF

(71) Applicant: YOUNG SUK LEE, Yongin-si (KR)

(72) Inventor: YOUNG SUK LEE, Yongin-si (KR)

(21) Appl. No.: 16/393,979

(22) Filed: Apr. 25, 2019

(30) Foreign Application Priority Data
Mar. 19, 2019 (KR) 10-2019-0031190

(51) Int. Cl. G09B 19/00; G09B 3/02

(52) U.S. Cl. CPC G09B 19/00; G09B 3/02

(57) ABSTRACT

Disclosed is a seven steps learning study book of Ruah education includes a plurality of volumes having twelve learning themes related attentiveness, positive attitude, joyfulness, caring, gratefulness, obedience, patience, responsibility, self-control, creativity, honesty, wisdom; wherein the each volume of the learning theme divided into ‘open step’, ‘step 1’, and ‘step 2’, which enables selective learning corresponding to the age of the learner. The each volume of the learning theme includes a first step of Thinking time page 111, a second step of Story time page 112, a third step of Imagine time page 113, a fourth step of Action time page 114, a fifth step of Build-up time page 115, a sixth step of Sharing time page 116, and a seventh step of a Repetitive education page 117.

This application claims priority to and the benefit of Korean Patent Application No. KR 10-2019-0031190 filed on Mar. 19, 2019 in the Korean Intellectual Property Office, the entire contents of which are incorporated herein by reference.

### TECHNICAL FIELD

The present invention is to a seven steps learning study book of Ruah education and a Ruah learning method using thereof, and more specifically to the seven steps learning study book of Ruah education and the Ruah learning method using thereof, which including 12 learning study themes related to human character: attentiveness, positive attitude, joyfulness, caring, gratefulness, obedience, patience, responsibility, self-control, creativity, honesty, wisdom, and each learning theme consists of the sevens step learning study pattern of Ruah education.

### BACKGROUND ART

At present, most social members are aware of the social pathological phenomenon brought by the educational environment of the social climber of entrance focus, but are not able to change the educational environment for college admissions and employment for large corporations. In addition, instructor-led and memorizing methods that are appropriate for the era of industrialization are still being implemented as the main method of education, or students are repeating the method of studying alone, because of the educational environment that the members only have to pass the exam. This reality has become a barrier to failure to train talent required by the knowledge-based society and the era of the Fourth Industrial Revolution.

In addition, some country's education has been devastated by entrance focus and social climber (or success-oriented) education. Individuals who have been educated on the basis of success thinking have built up a good specification with a lot of knowledge and have thinking that the specification is a shortcut to success that ensures a good job again. Even today, cram and memorizing education are the main subjects only for passing the exam, and the way of studying alone is repeated.

In the process, many parents and students are suffering to give up their present happiness for future success, and those who are taken away from success are captivated by inferiority and defeat. The stigma of both the bottom of the OECD countries' suicide rate for the 12th years and the bottom of the youth's happiness index shows that excessive entrance focus and social climber education are making the society worse.

In addition, the entrance focus and social climber education have also caused our educational system to fail to adapt to the times. Since the early days of industrialization, our society has been operating an educational system that produces a large number of people with standardized knowledge and skills. Numerous people who have learned certain knowledge and skills through instructor-led, cram, and memorizing education have played a role of human capital causing national economic development.

However, as our society is transformed from the industrial society to the knowledge-based society, it is becoming clear that it could not cultivate talent for future society. The Knowledge-based society defines people who can produce, distribute, utilize and fuse knowledge and information as the talent. In other words, it is to define the talent who fuses knowledge to lead creative industries.

What is the reason why our society could not cultivate creative talents? It is because the education of our society is all about “How can we go to prestigious universities and big corporations with good grades in current educational system”.

In addition, the fourth industrial revolution, represented by an artificial intelligence and, a robot, calls for the need to develop innovative talent. In 2016 World Economic Forum's Occupation Report, “Over 7 million jobs in worldwide disappear in 5 years and 2 million new jobs are created.” There is a prediction that “currently, 65% of primary school will be engaged in a job which are not at present.

As the Fourth Industrial Revolution brought about a rapid paradigm shift in various areas of our lives, the capacity of future social workers is also changing.

Indeed, the World Economic Forum WEF has proposed ‘Basic competence’ such as literacy and infiltration ability, ‘Competence’ such as cooperation, communication, and ‘Personality’ such as creativity, initiative, and challenge spirit as the technology required in the 21st century. It is clear that the major change in the ‘education system’ is inevitable in order to cultivate talent with creative and convergent ability to move away from the existing educational system, which was composed of the cram and the instructor-led.

Therefore, we are moving away from the entrance focus, the social climber educational environment and the programming education method, which are optimized for such educational environments, while cultivating talents who pursue success and happiness at the same time, the education system and the education method are needed to train the talent person to demonstrate their capabilities in the rapidly changing era.

### DISCLOSURE

### Technical Problem

Therefore, the object of the present invention is to provide a seven steps learning study book of Ruah education and a Ruah learning method using thereof, which have a variety of educational content and teaching methods that change the learners' thinking, feeling, and action to meaningful effects by teaching the 12 learning study themes related to human character through the Ruah 7th level learning pattern,

Other object of the present invention is to provide a seven steps learning study book of Ruah education and a Ruah learning method using thereof, which are provided a character education course that gives meaningful influence to thinking, feeling, and action through education to foster good character leaders.

Another object of the present invention is to provide a seven steps learning study book of Ruah education and a Ruah learning method using thereof, which are developing children's logical and creative thinking skills using ‘the Child Education Act’ by using technology to change thinking—questioning, technology to change feeling—attentiveness, and technology to change action—positive feedback, ‘character praise’, ‘character discipline’

Additional object of the present invention is to provide a seven steps learning study book of Ruah education and a Ruah learning method using thereof, which is to train future talents with good character by bringing about ultimate character change through questions that raise good thinking, discussions that develop good feeling, and presentation that raises good action through detailed communication such as questions and discussions and by bringing out the ultimate character change by through providing the practical education method to apply the truth to the life and practice it based on the thinking-feeling-action understanding of the knowledge system.

Meanwhile, the object of the present invention is not limited to the above-mentioned objects, and other objects not mentioned can be clearly understood by those skilled in the art from the following description.

### Technical Solution

According to an aspect of the present invention, there is provided a seven steps learning study book of Ruah education comprises a plurality of volumes having twelve learning themes related attentiveness, positive attitude, joyfulness, caring, gratefulness, obedience, patience, responsibility, self-control, creativity, honesty, wisdom; wherein the each volume of the learning theme divided into ‘open step’, ‘step 1’, and ‘step 2’, which enables selective learning corresponding to the age of the learner, wherein the each volume of the learning theme includes a first step of Thinking time page 111, a second step of Story time page 112, a third step of Imagine time page 113, a fourth step of Action time page 114, a fifth step of Build-up time page 115, a sixth step of Sharing time page 116, and a seventh step of a Repetitive education page 117.

According to the other aspect of the present invention, there is provided a seven steps learning study book of Ruah education comprises a plurality of volumes having twelve learning themes related attentiveness, positive attitude, joyfulness, caring, gratefulness, obedience, patience, responsibility, self-control, creativity, honesty, wisdom; wherein the each volume of the learning theme includes a learning page portion 110, which is enable the learning of the steps of each learning theme, having a first step of ‘Thinking time’ page 111, a second step of ‘Story time’ page 112, a third step of ‘Imagine time’ page 113, a fourth step of ‘Action time’ page 114, a fifth step of ‘Build-up time’ page 115, a sixth step of ‘Sharing time’ page 116 and a seventh step of a Repetitive education page 117; an auxiliary learning page portion 120, which is assist the class the learning page portion 110, having a theme definition learning page 121, a Ruah theme song learning page 122, a Ruah rule learning page 123, a theme chant learning page 124, a theme story learning page 125, a theme game board page 126, a sticker page 127, a picture card page 128; a cover page portion 130 for accommodating the learning page portion 110 and the auxiliary learning page portion 120 are accommodated; and an opening hold cover portion 140 configured to accommodate or attach the cover page portion 130 selectively and to maintain the unfolded state of the corresponding pages during the learning.

Also, the opening hold cover portion 140 comprises an adhesive band 141, configured on the outer surface of the cover page portion 130, and formed a predetermined length corresponding to both lengths of the cover page portion 130 in the unfolded state and closely adhere the outer surface of the cover page portion 130 as means for allowing the learner to concentrate on the learning so that the expanded state of the pages is stably maintained; a folding preventing rolling bar 142, which is configured to be able to bend or roll with a predetermined length on both side portions of the center of the adhesive band 141, for stably maintaining the unfolded state of the pages when folded or rolled toward the outer surface of both sides of the center of the cover page 130; a bookmarking rolling bar 143, which is configured to be folded or rolled while having a predetermined length at both ends of the adhesive band 141, for providing a bookmarking function for the learned page by covering the edges of the pages when folded or rolled toward the inner surface of the edge portion of the cover page portion 130; and an anti-rolling bar 144, formed in the portion of the adhesive band 141 between the folding preventing rolling bar 142 and the bookmarking rolling bar 143, for stably maintaining the unfolded state of the pages by preventing the portion of the adhesive band 141 between the folding preventing rolling bar 142 and the bookmarking rolling bar 143 from rolling during rolling of the folding preventing rolling bar 142.

### Advantageous Effects

Therefore, the present invention has an advantage which provides a variety of educational content and teaching methods that change the learners' thinking, feeling, and action to meaningful effects by teaching the 12 learning study themes related to human character through the Ruah 7th level learning pattern.

In addition, it provides the effect of cultivating good character leaders through character education curriculum which gives meaningful influence to thinking, feeling and action through education.

In addition, it is provided to a seven steps learning study book of Ruah education and a Ruah learning method using thereof which are developing children's logical and creative thinking skills using ‘the Child Education Act’ by using technology to change thinking—questioning, technology to change feeling—attentiveness, and technology to change action—positive feedback, ‘character praise’, ‘character discipline’

In addition, it is provided to a seven steps learning study book of Ruah education and a Ruah learning method using thereof which are training future talents with good character by bringing about ultimate character change through questions that raise good thinking, discussions that develop good feeling, and presentation that raises good talking through detailed conversation such as questions and discussions and by bringing out the ultimate character change by through providing the practical education method to apply the truth to the life and practice it based on the thinking-feeling-action understanding of the knowledge system.

It also provides the effect of cultivating children's logical thinking ability and creative thinking ability as a child education law by ‘technology to change thinking—questioning, skill to change feeling—attentiveness, technology to change action—positive feedback, character praise, and the ’ character discipline)

It also provides the effect of training future talents with good character by bringing about ultimate character change through questions that raise good thinking, discussions that develop good feeling, and presentation that raises good talking through detailed conversation such as questions and discussions and by bringing out the ultimate character change by through providing the practical education method to apply the truth to the life and practice it based on the thinking-feeling-action understanding of the knowledge system.

On the other hand, the effects of the present invention are not limited to the effects mentioned above, and other effects not mentioned can be clearly understood by those skilled in the art from the description of the claims.

### DESCRIPTION OF DRAWINGS

FIG. 1 is a conceptual diagram schematically showing a configuration of a seven learning study book of Ruah education according to an embodiment of the present invention;

FIGS. 2A to 8 are diagrams each illustrating a learning page of the first to seventh steps of learning of Ruah education in the learning study book of FIG. 1;

FIGS. 9 to 16 are diagrams for explaining a theme definition learning page for Ruah learning study, Ruah theme song learning page, Ruah rule learning page, theme chant learning page, a theme story learning page, a theme game board page, a sticker page, and a picture card page in the Ruah learning study book of FIG. 1; and

FIGS. 17 and 18 are diagrams showing a configuration of a seven level learning study book of the Ruah education according to the embodiment of the present invention, respectively.

### BEST MODE

Hereinafter, preferred embodiments of the present invention will be described in detail with reference to the accompanying drawings.

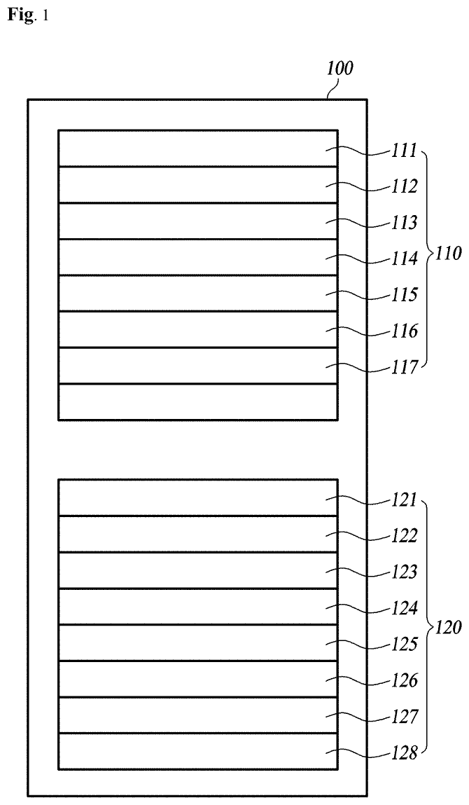

As shown in FIG. 1, a learning study book 100 of Ruah education according to the present invention includes each volume consists of twelve learning themes related attentiveness, positive attitude, joyfulness, caring, gratefulness, obedience, patience, responsibility, self-control, creativity, honesty, wisdom, and the each volume of the learning theme divided into ‘open step’, ‘step 1’, and ‘step 2’, which enables selective learning corresponding to the age of the learner. And each of the learning theme has a structure that is learned step by step through seven steps of a first step of Thinking time page 111, a second step of Story time' page 112, a third step of Imagine time page 113, a fourth step of Action time page 114, a fifth step of Build-up time page 115, a sixth step of Sharing time page 116, and a seventh step of a Repetitive education page 117.

At this time, 12 themes can be classified into themes related to empathy, and themes regarding conscience, and attentiveness, positive attitude, joyfulness, caring, gratefulness, obedience, patience, responsibility, self-control, creativity, honesty, wisdom are corresponding to the discrimination power.

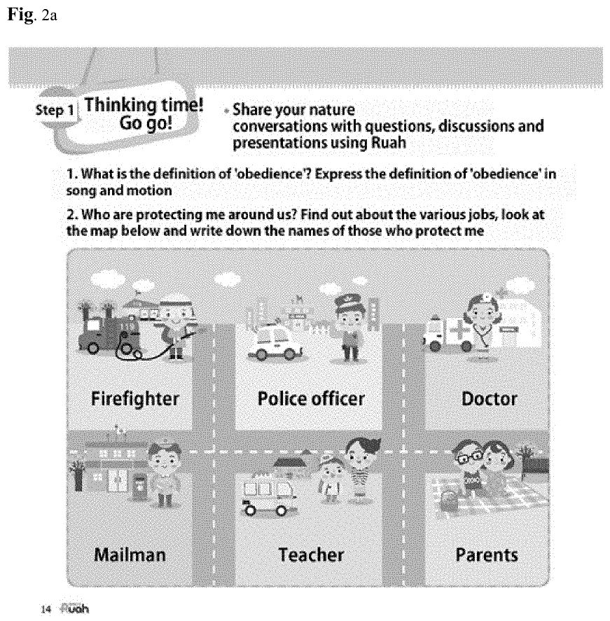

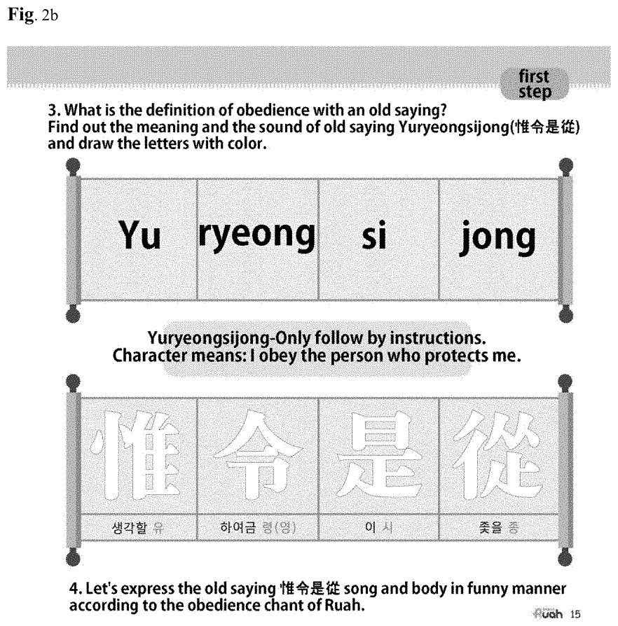

As shown in FIGS. 2A and 2B, the ‘Thinking time’ page 111, which is the first step of Ruah learning study, is for the purpose of practicing a thinking opening activity on the learning theme. The Thinking time page includes an area where a guidance sentence is described so that the learner may express a definition of the learning theme in songs and motions, recognize the definition of the learning theme through plays or games, learn meaning and sound of the definition or a main subject of the learning theme through old saying, and express and learn the old saying through the songs and chants.

Here, the definition of the corresponding learning theme enables the learner to review the definition of the learning theme by expressing the definition of the learning theme by the songs and the motions.

In addition, the definition of the learning theme can further improve self-participation through curiosity stimulation by writing words or drawing pictures in hands in the corresponding area according to the guidance sentence or an instruction of a teacher.

Also, such learning method can improve learners' self-participation and lead to progressive education since the main subject of the learning theme comprises old saying which is short but meaningful sentence and reveal the definition of the learning theme such as Korean 12 Character Education, and the learner attaches or detaches stickers matching to corresponding letters after learning the meaning and sound of the old saying.

It also enables the learner to review the main subject of the learning theme by expressing the main subject of the learning theme in song and motion (or body).

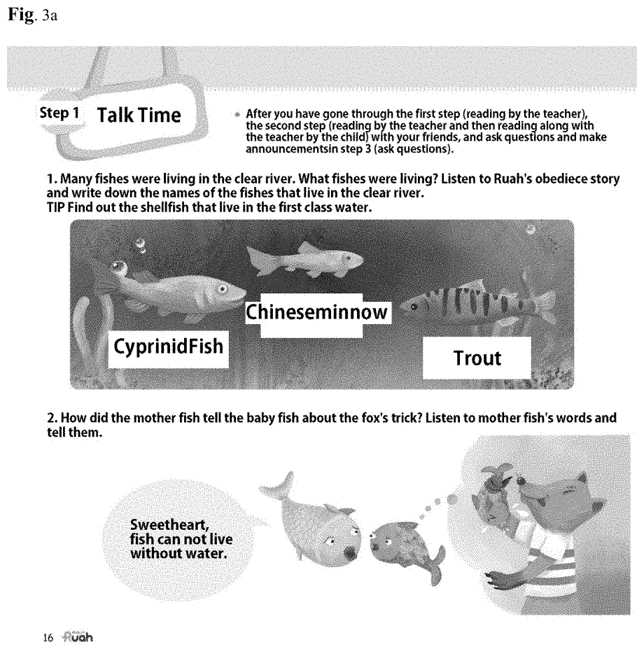

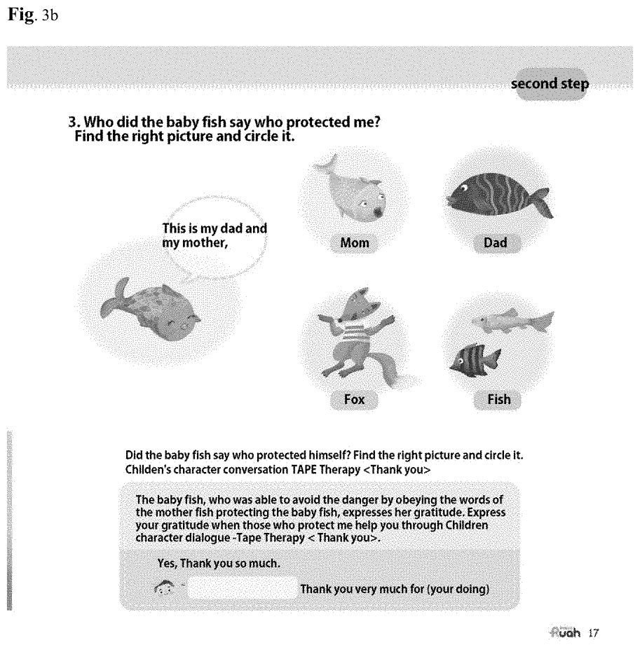

As shown in FIGS. 3A and 3B, the Story time page 112 which is the second step of Ruah learning study is for the purpose of practicing the Ruah story reading activity on the learning theme, and includes an area where the guidance sentence is described so that the learner and the teacher read the Ruah story about the learning theme and recognize the contents through questions.

At this time, the ‘Story time’ page 112 is preferably processed by the Ruah reading method. The Ruah reading method includes step 1 of reading the Ruah story and acting motions along with rhythm by the teacher, step 2 of allowing the learner to read the Ruah story and act the motions along with the rhythm taught by the teacher, step 3 of recognizing the content of the Ruah story through questioning and discussing, and step 4 of reading the Ruah story repeatedly by a group of three learners.

Here, the ‘Story time’ page 112 allows the learner to memorize and organize the learning contents, so that the learners write letters or draw pictures with the pencil in the corresponding area according to the teacher's question or guidance sentence after the steps 1 to 3 of the Ruah reading method are preceded.

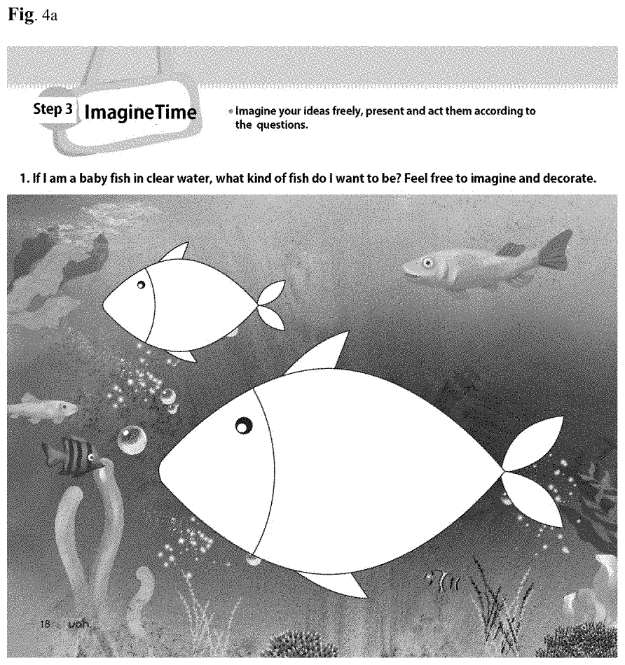

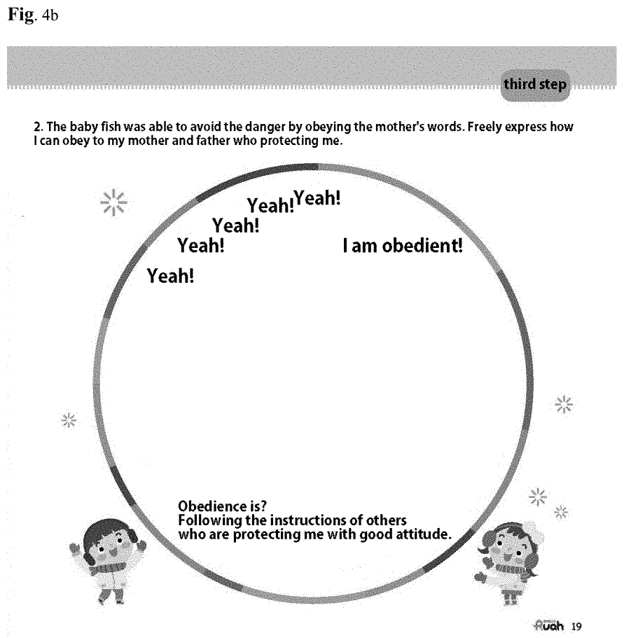

As shown in FIGS. 4A and 4B, the third step of the Ruah learning, the ‘Imagine time’ page 113, is for the purpose of practicing questions and discussion activities on the learning theme, and includes an area where the guidance sentence is described to develop creative thinking through various imaginings through asking questions and discussions after reading the Ruah story of the learning theme.

Here, the ‘Imagine time’ page 113 allows the learners to memorize and organize the learning contents, so that the learners can write letters or draw pictures with the pencil in the corresponding area according to a teacher's questions or guidance sentence, and freely imagine or present their answers by the learner.

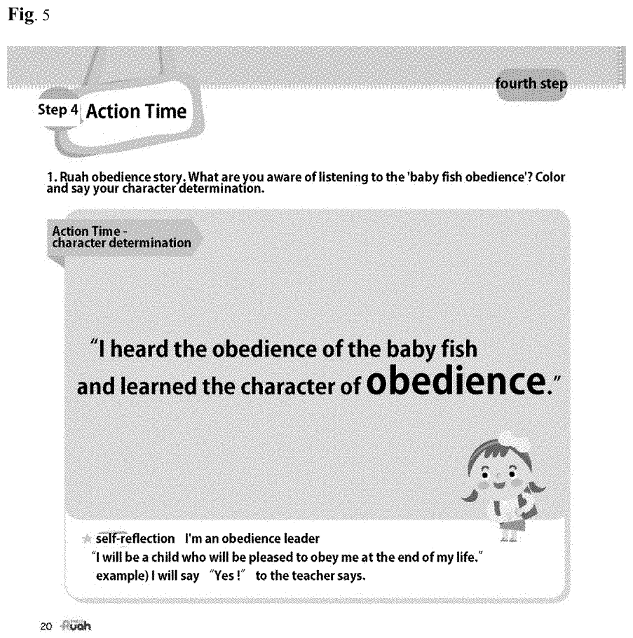

As shown in FIG. 5, the ‘Action time’ page 114, which is the fourth step of the Ruah learning, is for the purpose of practicing the self-reflection activity on the learning theme, and includes an area where the guidance sentence is described to make a decision what they realize and practice in action through the self-reflection after reading the Ruah story on the learning theme.

Here, the ‘Action time’ page 114 allows the learners to memorize and organize the learning contents, so that the learners can write letters or draw pictures with the pencil in the corresponding area according to the teacher's question or guidance sentence, and present their decisions.

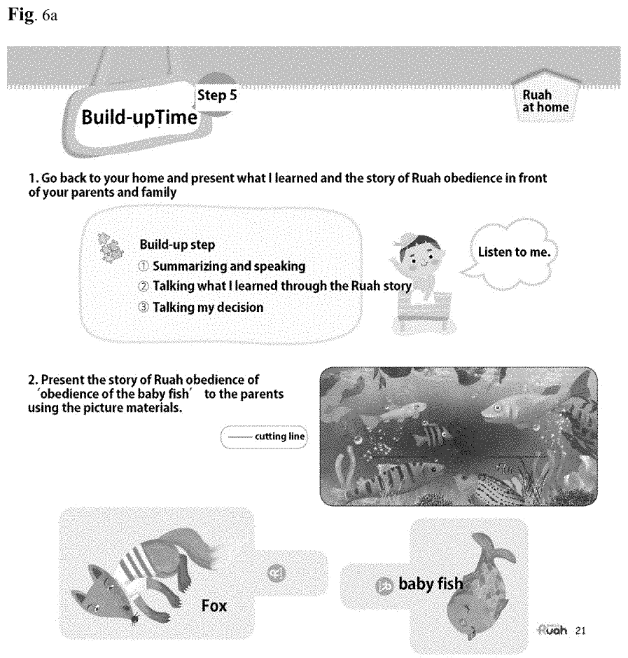

As shown in FIGS. 6A and 6B, the ‘Build-up time’ page 115, which is the fifth step of Ruah learning, is for the purpose of practicing a presentation activity on the learning theme, and includes an area where the guidance sentence is described to expand what they know by presenting in front of their parents and family at home what they learned in the Ruah story and the contents learned in all steps.

Here, the ‘Build-up time’ page 115 allows the presentation activity to proceed through a ‘build-up step’. The ‘build-up step’ includes a first step of summarizing and talking, a second step of talking what they learned through the Ruah story, and three step of talking my decision.

Also, the ‘Build-up time’ page 115 provides an area to present in front of their parents and family about the Ruah story using picture materials related to the learning theme. The above area stimulates the curiosity more, so that the learning effect can be promoted by making the learning attitude more advanced by letting the learner use the picture material as a tool or material necessary for the presentation by cutting out or pasting the picture material onto the area.

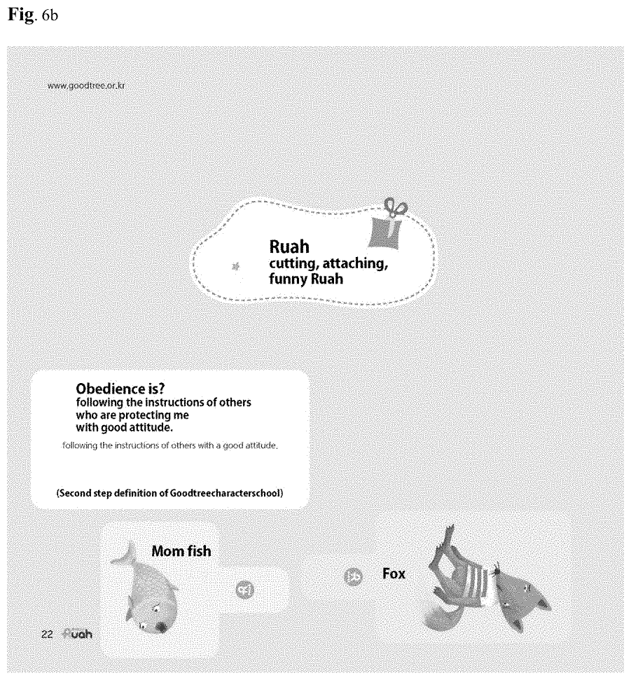

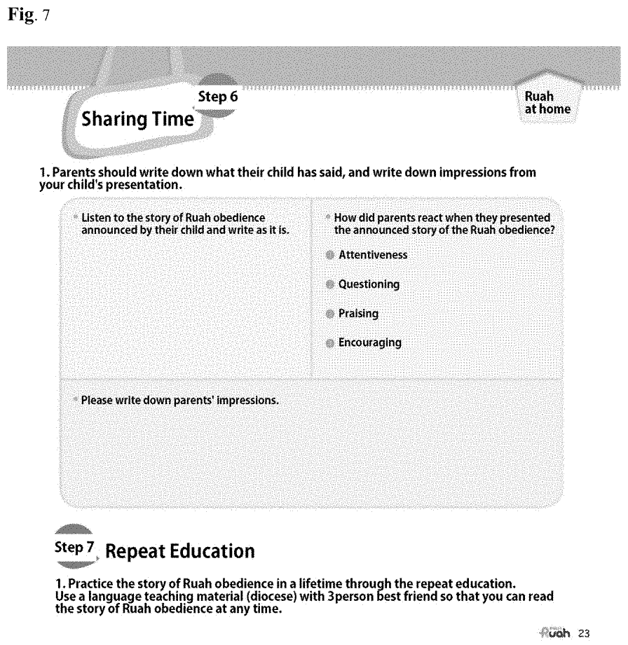

As shown in FIG. 7, the ‘Sharing time’ page 116, which is the sixth step of the Ruah learning, is for the purpose of practicing an exhibition activity on the learning theme, and includes an area in which the guidance sentence is described so that the parent write the contents of their child's presentations and impressions in the corresponding area to forward the teacher.

Here, the ‘Sharing time’ page 116 is divided into a first part of writing the Ruah story as the parent listen to their child's presentation, a second part of questioning and selectively answering by dividing attentiveness, asking questions, praising, and encouraging for the parents' responses when their child presents the Ruah story, and a third part of writing the parent's impression, so that the teacher can know the feedback about the activity of the learner ‘s 6 steps of Ruah learning level and the degree of education participation of the learner’ s parents or family.

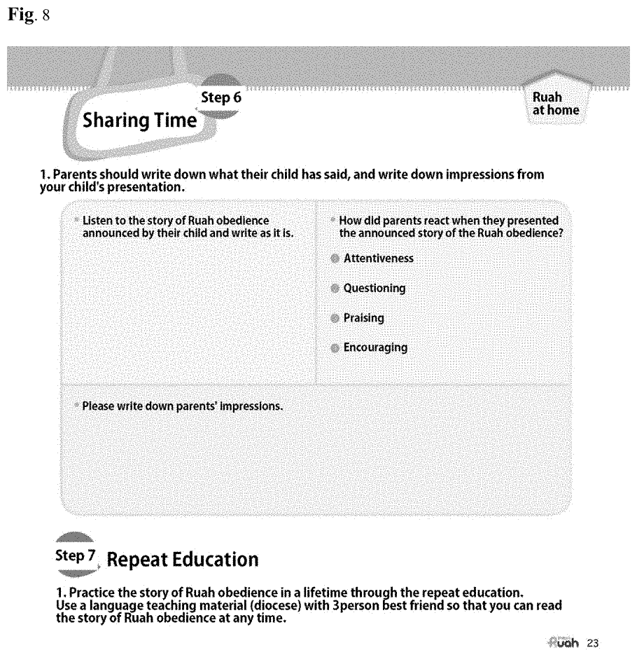

As shown in FIG. 8, the ‘Repetitive education’ page 117, which is the seventh step of Ruah learning, is for the purpose of practicing repetitive education activities on the learning theme, and includes an area where the guidance sentence is described to read the Ruah story repeatedly through the group activities of the three members explained in fourth step of the Ruah reading method, and to practice good thinking, good feeling, and good action.

Meanwhile, the seventh learning study book 100 of the Ruah education according to the present invention further includes a theme definition learning page 121 for learning a definition of the learning theme, a Ruah theme song learning page 122 for learning the theme song for the Ruah learning, a Ruah rule learning page 123 for learning the rules of Ruah learning, a theme chant learning page 124 for learning old words and songs for the learning theme, a theme story learning page 125 in which learners and teachers learn for imagining or freely talking a story based on illustrations of the learning theme, a theme game board page 126 for allowing the learners to practice the attitude of the learning theme while playing a game with friends through a game after the all steps learning for the learning theme, a sticker page 127 for stimulating learning curiosity, since the stickers corresponding to the main subject of the learning theme or the Ruah story needed in ‘Thinking time’ and ‘Story time’ steps during learning about the learning theme is attachable or detachable, a picture card page 128 that is used as an auxiliary tool, and meaning and the contents of the old saying about the main subject of the learning theme needed during the ‘Thinking time’ page are described on the one side and the other side of the sound.

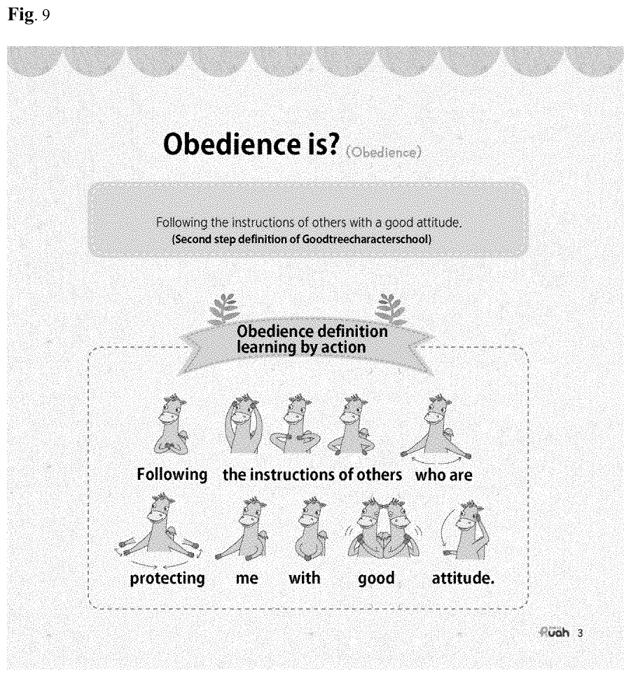

As shown in FIG. 9, the theme definition learning page 121 is for learning the definition of the learning theme to be learned before the ‘Thinking time’ learning step and includes an area in which the guidance sentence for learning the definition and operation of the learning theme is described.

Here, the theme definition learning page 121 includes a first part for describing a dictionary meaning or expression for the definition of the learning theme, a second part, in which pictures are described to express, for describing the definition of the theme of the learning to be expressed by a motion. It is possible to make the definition of the learning theme more effective in pre-learning and recognizing while learning subjects follow the action and words of the teacher.

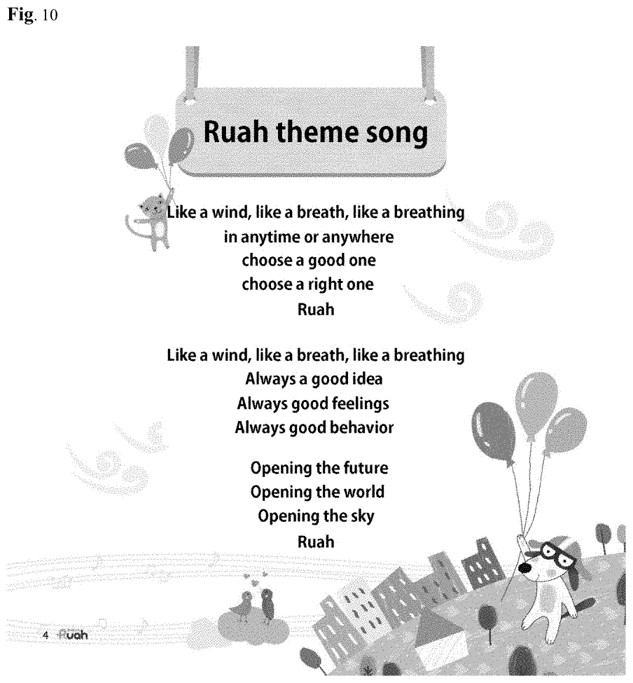

As shown in FIG. 10, the Ruah theme song learning page 122 is for learning of the theme song for the Ruah learning, and includes an area where a lyricsis written so that the teacher and the learners can sing the theme song of the Ruah learning themes.

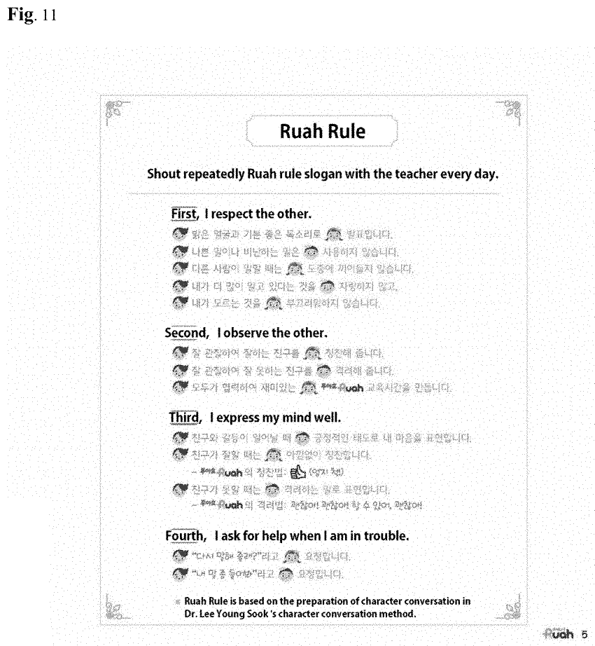

As shown in FIG. 11, the Ruah rules learning page 123 is for learning rules of the Ruah learning, and include an area where the rule is described so that the teacher and the learners repeatedly shout slogans daily to learn.

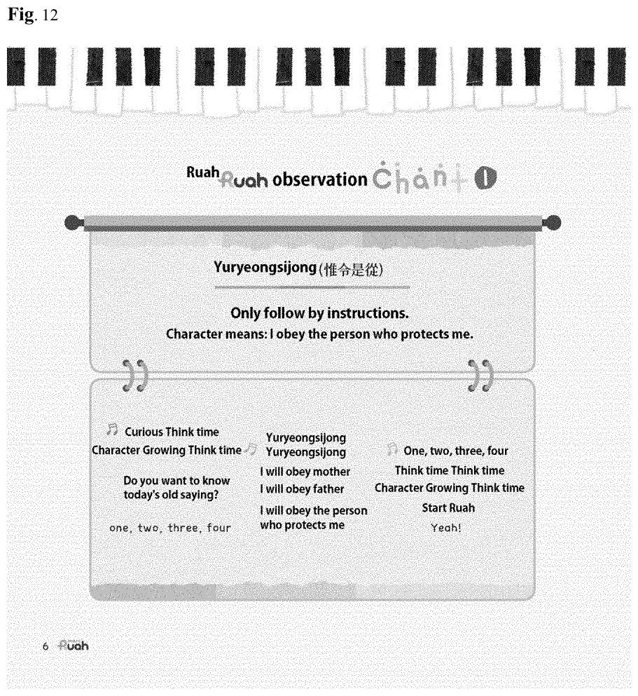

As shown in FIG. 12, the theme chant learning page 124 is for allowing the old saying and the song of the main subject of the learning theme to be learned before the ‘Thinking time’ learning step, and includes an area where an old saying and song about the main subject of the learning theme to be learned is described.

Here, the theme chant learning page 124 includes a first part where the old saying and the meaning of the main subject of the learning theme, and a second part where the lyrics for describing the main theme of the learning theme, and allows the learners to learn the main subject and the theme song of the learning theme according to the teacher's teachings.

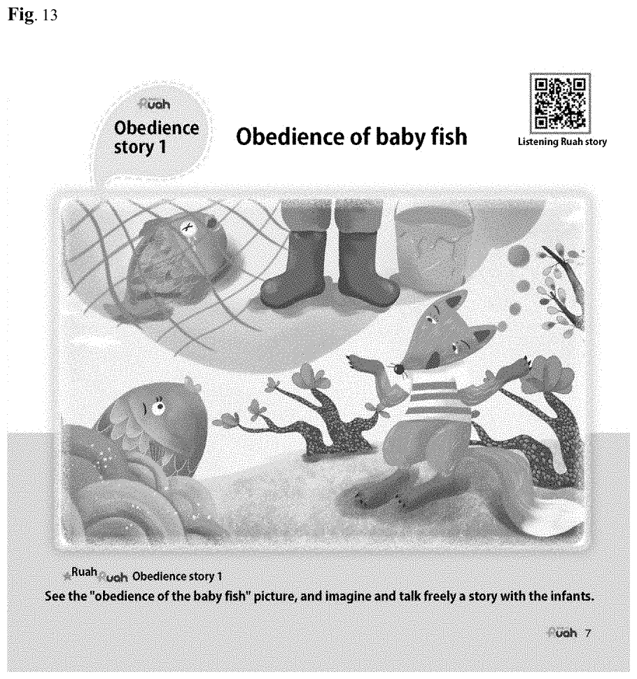

As shown in FIG. 13, the theme story learning page 125 is for the purpose of learning the Ruah story for the learning theme before or during the ‘Story time step, and includes an area in which a guide picture is described to allow the teacher and the learners to visually understand the contents when the Ruah story about the learning theme is conducted by the Ruah reading method.

Here, the theme story learning page 125 includes a first part where illustrations are drawn to allow the learner to visually see the contents of the Ruah story when the Ruah story is carried out by the Ruah reading method, and a second part where a QR code for maximizing a learning effect is printed so that the Ruah story according to the Ruah reading method is reproduced by a song and a video by a terminal such as a smart phone.

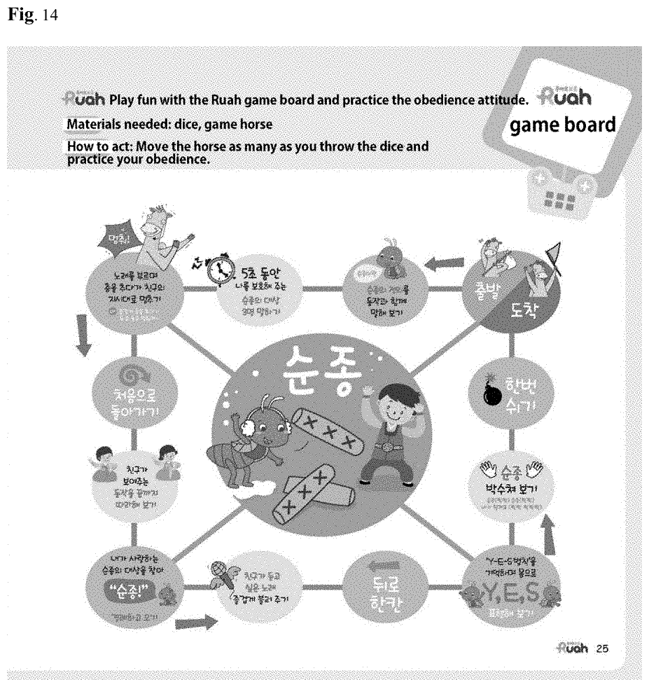

As shown in FIG. 14, the theme game board page 126 includes an area in which a guidance sentence is described to allow learners to practice their attitudes on the learning theme while playing fun with friends and playing games after learning in all steps for the learning theme.

Here, the theme game board page 126 includes a part where a game rule and a game board are drawn, so that learners and friends move a dice and a gaming horse as many as the number of the dice to perform a mission guided to the part where the horse is located.

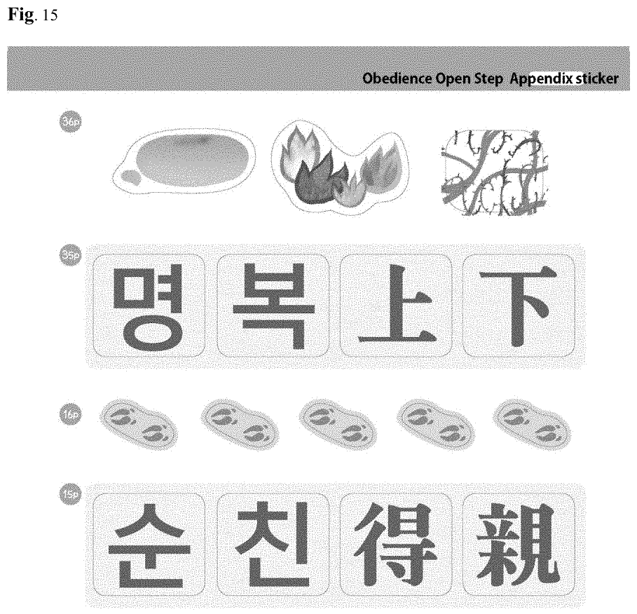

As shown in FIG. 15, the sticker page 127 is configured such that such that the sticker is attachable or detachable, where the sticker is corresponding to the main subject of the learning theme or the Ruah story required in the ‘Thinking time’ and ‘Story time’ steps of learning study for the learning theme.

Here, the sticker page 127 includes a first part where the sticker necessary for the step of the learning theme is detachably adhered, and a second part where the page number of the step to which the sticker is to be adhered, so that it can stimulate learners' curiosity of learning and improve their participation in learning.

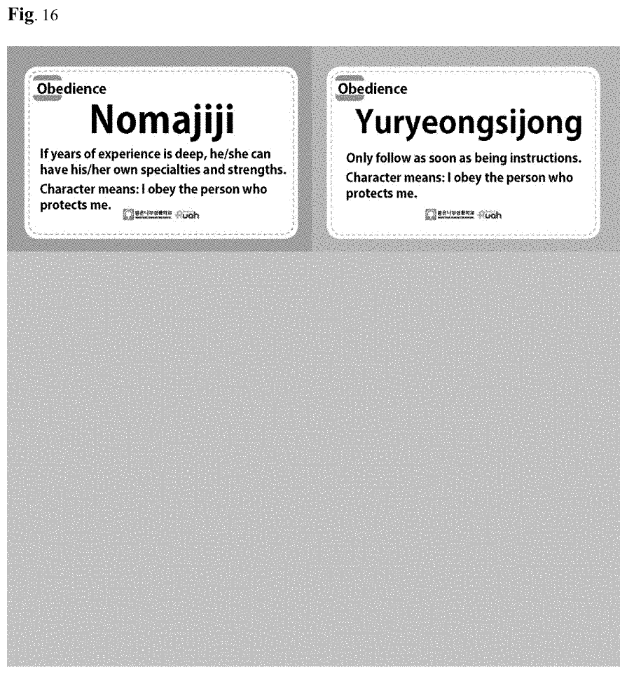

As shown in FIG. 16, the picture card page 128 is configured such that the picture card is attachable or detachable where the picture card is used as an auxiliary tool and the sound, the meaning, and the contents of the old saying about the main subject of the learning theme, that is needed during the ‘Thinking time’ step of learning about the learning theme, are written on one side and the other side of the picture card.

Here, the picture card page 128 may have a structure in which the picture card is cut or taken off. On the other hand, Chinese character of the old saying and the meanings and sound for each Chinese character are described one side of the picture card page, while pronunciations and its meaning for each Chinese character of the old saying are described the other side, so that the picture card page is to be used as an auxiliary tool in learning study and the learning effect on the old saying can also be improved.

On the other hand, Ruah's dictionary meaning is ‘character,’ that means the character from birth, and means spirit, breath, and wind of God in Hebrew, and the Ruah is used to emphasize human good will.

That is, the Ruah learning method according to the present invention can be said to be the education method that aims to breed up the happy future talent as the ultimate goal.

In the present invention, when character is defined as expression of one's thinking, feeling, and action, we must change our existing thinking, feeling, and action into better thinking, better feeling, and better action to develop a good character, thereby achieving through character education.

For example, character education is a process of making meaningful changes in thinking, feeling, and action through education, the Ruah education method is a concept that encompasses a variety of educational contents and educational methods that change into better character by mediating meaningful influence on learners' thinking, feeling, and action.

In addition, the Ruah education method is a learning method aimed at improving learning ability through activities such as ‘question’, ‘presentation’, and ‘discussion’ through character communication method, and the Ruah education method can cultivate children's logical thinking ability and creative thinking ability by utilizing education methods of the technology of character communication ‘the skill of changing the thinking—question method, skill to change feeling—attentiveness, technology to change action—positive feedback, character praise, and character education as a child education method.

In addition, the Ruah education method uses detailed communication methods as educational methods such as questions and discussions, such as Socratic question method and Harbrough question method.

The Ruah learning method of the present invention brings out about ultimate change in character through questions for developing good thinking, discussions for promoting good feeling, and presentation for promoting good action and it becomes a practical educational method to realize the truth and apply and practice in their life based on the thinking-feeling-action understanding of the knowledge system.

Therefore, when the learners learn using the Ruah learning method of the learning study book of the 7th steps of the Ruah education according to the present invention, it is expected to be able to cultivate future talents with good character.

The 12th themes underlying the Ruah education method are deeply related to the twelve character of humans, especially Koreans.

The character of Koreans is negatively shaped in part due to be Influenced by the oriental relational culture, the Confucian culture, the negative functions of Jeong ( [symbol] ), Han ( [symbol] ), and shamanism. In order to improve this, Korean 12 Character Education aims to help people express their thinking, feeling, and action in character training.

In addition, 12 character education aims to educate the empathy, the conscience and discerning virtue at the same time so that the learners can distinguish between right and wrong, while agreeing with others' feeling.

And 12 character education focus on opening the door of the relationship and restoring the intimate relationship through the “secret of relationship-TAPE therapy”.

Table 1 is a graphical representation of the secret of relationship-TAPE therapy according to the present invention.

As shown in Table 1, the present invention is to understand the concept of horizontal relationship and vertical relation and to develop proper character through balanced learning of ‘thank you’, ‘apologize’, ‘please’, ‘express’.

Finally, the present invention is to educate learners to be able to overcome difficult problems and conflicts by choosing their thinking, feeling, and action responsibly by reflecting on themselves.

This is referred to as the Korean 12 character education, which presents a systematic way of teaching and methodology including two basic virtues of empathy and conscience and twelve thematic character embodying in order to be able to apply a good character in the educational field, unlike the existing personality education has only problems and limitations due to only maintain an acquisition of abstract knowledge.

Empathy is “an ability to empathize with other people's basic feeling, pain and joyfulness, pain and sorrow, to reduce feeling impact based on comprehension of others, not compassion”.

Conscience is “an ability to distinguish between good and evil based on the basic conscience of man, and a virtue that is the basis for proper living, healthy citizenship, and moral action.

When these two virtues are used as pillars, various values can extend from this pillar as the branches as extended.

Table 2 shows the ‘two basic virtues’ models of Korean 12 character education

As shown in Table 2, the six good character of attentiveness, positive attitude, joyfulness, caring, gratefulness, obedience grow through the empathy, and patience, responsibility, self-control, creativity, honesty, wisdom grow through the conscience.

The Ruah education method of the present invention is based on the basic direction of Korean 12 character educational focusing on restoring happy relationship with others after each learner reflects on himself and expresses his thinking, feeling and action well.

In addition, it has the same advantages as the Korean 12 character education methods in that it can learn and train by the two basic virtues of empathy and conscience, and the 12th theme through various education methods.

In the present invention, it is desired to learn and implement a character communication which is a communication that helps people express their thinking, feeling and action through communication to be expressed in a better character.

This is a communication that grows each other's character by communicating with the speaker's thinking, feeling, and action with a communication for accepting an individual's thinking, minds and action and opening other's mind to create an intimate relationship.

In order to have the character communication, the learners have to prepare four minds. The first of the four minds is a respectful mind. The character communication begins with respect for the other person. “Respect is the attitude that acknowledges and elevates its value by treating me and others with respect and care.” It is said that the words that you can easily conceive a child's thinking and action such as “You always look like this” or “It is always like that”. These come out when there is no respect for others. These words ruin the relationship.

It can stop the tagged words as beginning a communication with respect for children.

Second, it is the mind to observe. The character communication is a communication that observes children. This is a communication of emphasizing the attitude of observing the motivations of the action rather than evaluating the child with only the revealed action. The philosopher Krishna Muerty concurs with what he says is “the best form of human intellect that does not evaluate and observe.” It is important to practice a communication that tells you exactly what you have observed before judging whether your child's action is acceptable or not.

Third, it is the mind to find the hidden desire behind the feeling. We must find the hiding behind the feeling of the speech. For example, if your child says “Dad never understands me”, Dad needs to express his desire to hide behind the speech, ‘Dad, please understand me’ rather than reacting to the negative feeling of the speech. There are several basic human needs such as the desire for freedom to choose the aim itself, the desire to be celebrated on the anniversary, the desire to interdependence in the community, the desire to be recognized for his individuality, the desire for fun, the desire to pursue physical satisfaction, and the desire to be spiritually satisfied.

Fourth, it is the mind to request. The character communication expresses his hidden desires by asking. The mindset to ask for what his want without enforcing enriches the relationship.

There are two ways to effectively ask for it. First, it is asked for concrete action. Ambiguous expression causes confusion inside, which makes the relationship frustrating. Second, ask in a positive language. For example, if you ask “Do not”, it provokes rebellion. But it is more effective to say positively, such as “Let the computer finish every homework and only one hour”.

There are three types of skill of the character communication.

The first is the skill of changing the thinking—the questioning method is a communication skill that can effectively change the thinking without saying “do not” or “do.” The four questions of the character communication are how question method, futuristic question method, open question method, and direct question method. It is recommended to use the 4 methods to open your child's thinking. The question is makes an opponent think about his problem and find out and open how to solve it himself.

Second, ‘the skill of changing feeling—attentiveness method’ is a skill to observe and listen well to the thinking and feeling of children. Parents must listen to open your child's heart. If you actively listen, your opponent will open their hearts with a sense of respect. When attentiveness, it is important to let the other person feel that you are attentiveness.

Third, ‘the skill of changing action—positive feedback and character praise’ is a skill that gives specific motivation to change the action of the opponents by conveying positive and future-oriented feedback on the opponent's action. The positive feedback is a way to praise and encourage opponents in their action.

The present invention can achieve the following six educational objectives through the Ruah education method. First, establishing identity. Second, cultivating self-esteem. Third, expanding logical thinking ability. Fourth, build social relationships well. Fifth, promoting language development. Sixth, developing creative thinking.

These six educational aims can be an appropriate educational aim to train future talents of good character. This is accomplished through questions, discussions, and presentations based on the Ruah story (Bible, Talmud, Aesop's fables, etc.). The ultimate aim of education is to grow the learners into happy future talents.

The Ruah education method consists of a total of seven steps including step 1 Thinking time, step 2 Story time, step 3, Imagine time, step 4 Action time, step 5 Build-up time, step 6 Sharing time, step 7 Repetitive education.

Thinking time, which is the first step of the Ruah education method is a process of stimulating the brain through 4 Chinese character idiom, proverbs, character songs and chants, and games related to the 12 themes of Korean 12 character education of attentiveness, positive attitude, joyfulness, caring, gratefulness, obedience, patience, responsibility, self-control, creativity, honesty, wisdom

The short but meaningful sentences, such as the 4 Chinese character idiom and the proverbs, raise children's intellectual curiosity. In addition, rhyme in song and chant stimulates auditory as well as visual, and helps mental relaxation to enhance children's concentration. The game is a way to maximize the interest of children's, it not only stimulates students' brains through simple games, but also has an effect on physical stimulation.

Story time which is the second step of the Ruah education method is a process of reading various stories made in Ruah education programs with teachers and friends and reading the story together and recognizing the contents through questions. The process of reading and asking questions is based on the “Ruah Reading Method 4 steps”.

The first step of the Ruah reading method is that the teacher first reads the Ruah story. At this time, it is important to read along with the rhyme and motions. The main feature of the Ruah story is rhythm and motion that are the rhythm used in a rap and a beat of 70 beats for a child's heart rate. At this time, the rhyme is provided according to the age level so as to increase the interest of the children, and it is desirable to be expressed their body by motion while moving the body.

The teachers implement the rhyme and body motions in the story to increase the concentration of children.

The second step of the Ruah reading method is the reading by the teacher and the reading by the child, at this time, the teacher guides the children to follow the rhyme and body motion and read them together.

The third step of the Ruah reading method is a process of recognizing the content of the Ruah story through questions and discussions. The questions and discussions help to understand the story in a subjective and stereoscopic way without understanding it in a passive or fragmentary way. The step 3 develops logical thinking by following the flow of Ruah story.

The fourth step of the Ruah reading method is a process of repeatedly reading the Ruah story by grouping with three learners. At this time, the four step guide together to help everyone understand by making a level difference such as upper, middle, and lower level in an unit group.

Imagine time which is third step of the Ruah education method is a process of reading the Ruah story and then to develop creative thinking through questions and discussions. The questioning refers to the way in which he child's thinking is specified and expanded by asking the children. The questioning express the potential ability of children, stimulate language development, promote their thinking. However, asking the teacher or parent to derive a set of answers does not help to develop creative thinking.

The more open and divergent question enhance the children's creative thinks. The discussion is also a good learning method for developing children's creative thinking as a field where children can freely express various thinking, feeling, and action.

Action time which is forth step of the Ruah educational method is a process of reading the Ruah story and deciding on self-reflection to realize it and act upon it. Through determination, the learner can clearly summarize how he should practice what he haves learned. The teacher may guide to express writing or drawing what he make decisions.

Build-up time which is fifth step of the Ruah educational method is a process of expanding what he know by telling parents and family about the Ruah story at home he have been learning. Sharing what the learner haven learned with others is an effective learning method that allows the leaner to memorize the learning contents for the longest and many.

According to the National Learning Laboratories' Study Learning Pyramid study in the United States, learning contents of attentiveness, reading, and learning can be remained only 5% or 10% after 24 hours. But if the learner shares and teaches what he learn from others, he will remember the learning contents more than 90%.

Build-up time step is a process of heightening the relationship between parents and children. Build-up time provides a valuable communication time for improving the self-esteem of children and forming strong relationship between parents and children by forwarding the parent positive feedback for present what the child has learned, as a result of the food time or bed time education increase their relationship by sharing good thinking, feeling, action.

Here are the tips to make the presentation. The children presents in front of their parents:

1. Summarizing and talking

2. Talking what learners learned through the Ruah story

3. Talking my decision

On the other hand, parents who has heard a child's presentation expresses Ruah feedback as follows. If parents give feedback in the order of character question→character praise→character feedback, it is effective in improving the character and self-esteem of children since the parents can specifically encourage and praise their children.

Sharing time which is sixth step of the Ruah educational method is a process in which each parent writes the contents of their children's presentation on the Ruah workbook and writes their impression and returns an educational institution. The educational institution encourage children's self-esteem and motivate children to achieve the followings by presenting and display the parent feedback to the learners.

Table 3 shows a seven steps model of the Ruah educational method.

As shown in Table 3 above, Repetitive education which is seventh step of the Ruah educational method is a process repeatedly reading the Ruah learning study book sent to the educational institution from each home, and practicing good thinking, good feeling, and good action. The each group having 3 best friends played with group, it is used as a textbook/diocese of language field by educational institutions so that the learners can read the Ruah story repeatedly at any time.

At this time, the reason for grouping in 3 learners is to make them experience various differences of thinking, difference of feeling, differences of action, and become modelers or motivators for each other in the case of difference in upper, middle, and lower levels, as do not stay in private learning.

Particularly, each group having three learners is more advanced than the group having two learners (various opinions exchanges) to conduct question, discussion and presentation, and this is more stable in a small group than in a group having four learners (Not reluctant to many in relation).

In the class according to the Ruah education method of the present invention, the following rules can be set and the class can be conducted according to the predetermined rules.

First, I respect your opponent.

\textcircled{1} Teacher: “With a bright face and pleasant voice”

Learner: “I will present.”

\textcircled{2} Teacher: “Bad words or accusatory words”

Learners: “I will not use.”

\textcircled{3} Teacher: “When others say”

Learners: “I will not break in the middle.”

\textcircled{4} Teacher: “What I know a lot more”

Learners: “I will not boast,”

\textcircled{5} Teacher: “What I do not know”

Learner: “I will not be ashamed.”

Second, observe the other.

\textcircled{1} Teacher: “I observe well, if I have a good friend.”

Learners: “I will praise you.”

\textcircled{2} Teacher: “I observe well, if I have a not good friend.”

Learners: “I will encourage.”

\textcircled{3} Teacher: “We all work together.”

Learners: “We create a fun Ruah training time.”

Third, I express my mind well.

\textcircled{1} Teacher: “When a conflict occurs with friends”

Learners: “I will express my mind with positive attitude.”

\textcircled{2} Teacher: “When my friend is doing well.”

Learners: “I will generously praise.”
Ruah's praise method: Thumb up!

\textcircled{3} Teacher: “When my friend could not do.”

Learners: “I will express in encouraging words.”
Ruah's encouragement method: It's okay, it's okay, you can do it, it's okay!

Fourth, I ask for help when I have trouble.

\textcircled{1} Teacher: “Tell me again?”

Learners: “I will request.”

\textcircled{2} Teacher: “Listen to me.”

Learners: “I will request.”

The above rules can help learners become aware of the rules and make learning easier since each time the Ruah class is taught, the teacher reads ahead and then the learner reads the relevant part.

In addition, the teaching of the Ruah educational method of the present invention requires character communication skill that teachers and parents must learn and train, helping the questions that are delivered to children become diffusive and open questions, not convergent questions.

In other words, it is the character communication skills for enhancing children's creative and logical thinking.

The character communication skills of the Ruah educational method are as follows.

(1) Skill to Open Up Thinking—Questioning Method

It will open opponent minds and help activate the brain through various questioning methods.

(Example) “What happened?” (How questioning method)

“Then what will you do next?” (Future directivity questioning method)

“What do you think?” (Open questioning method)

“How would you act if you were?” (Direct questioning method)

(2) Skill to Change Feeling—Attentiveness Method

First, I participate with open minded attitude.

Second, it shows the attitude of attentiveness well by looking eyes each other to concentrate.

(Example) “Oh˜I understand”.

“You thinking like this”.

Third, when opponent talk the story, you can intervene or listen without interrupting the story.

(3) Skill to Change Action—Positive Feedback, Character Praise, Character Discipline

(Example) “I'm glad to see you attentiveness to the story till the end”

“I will help you do what you have decided!”

“I'm proud of you”

The present invention as described above allows step-by-step learning to proceed from the first area to the seventh area, and each step has relevance each other.

The present invention as described above is achieved with a textbook of a learning method that is developed so that ask questions, discussions, and presentations is to be effective in the context of steps 1 through 7. The questions asked by teacher or parent step-by-step is required the use of four questioning methods based on the character communication method.

In addition, when the Ruah reading method is applied in the second step so that discussion can be available, and it was invented to present in step 5 the contents learned and practiced in steps 2, 3 and 4 to systematically train the presentation.

In addition, the present invention is configured to display by receiving the feedback contents from parents in step 6, and repeatedly use the Ruah learning study book in step 7 to remember series of questions, discussions, and presentations as happy experiences.

The present invention teaches twelve learning themes relating to human character through the Ruah seven-step learning pattern, so that it can provide a variety of educational contents and education methods that change the learners' thinking, feeling and action to a better character by meaningful influence.

In addition, the present invention can cultivate happy future talent through the character education course that has a meaningful influence on thinking, feeling, and action through education, and can make a desirable change, so that children's logical and creative thinking skill can be developed by using the children education method such as skill to change thinking—questioning method, skill to change feeling—attentiveness method, skill to change action—positive feedback method, character praising skill, and character of discipline.

In addition, the present invention can bring about ultimate change in character through detailed communication of questions and discussions, question of raising good thinking, discussion of developing good feeling, and presentation of good action and train future talents with good character by providing the practical education method to understand and apply truth to life based on the thinking-feeling-action understanding of the knowledge system.

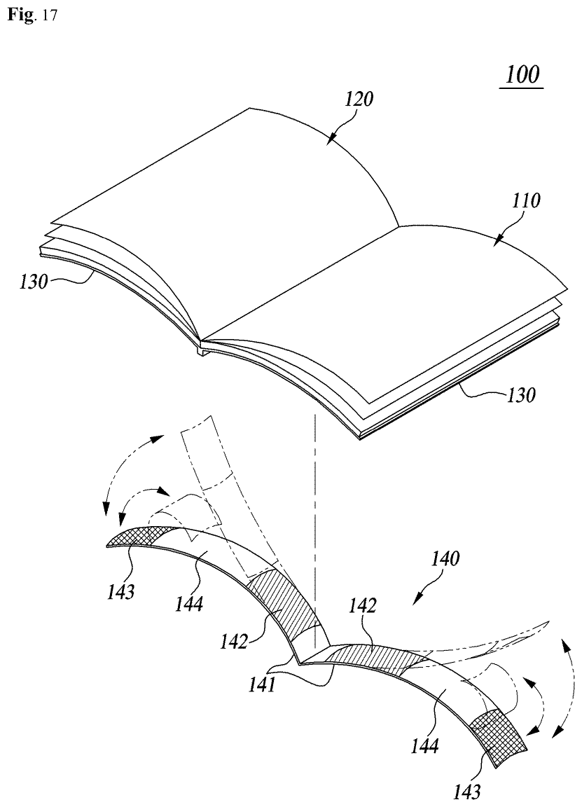

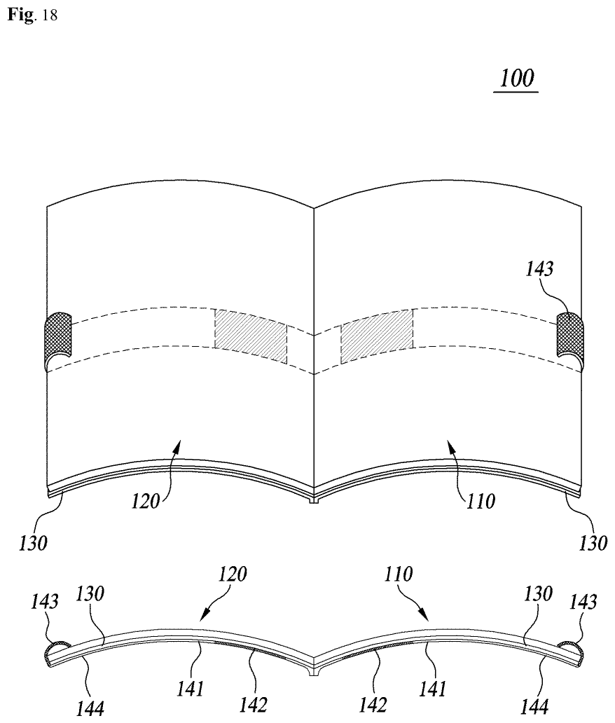

As shown in FIGS. 17 and 18, a learning study book 100 of the Ruah education according to the present invention includes each volume consists of twelve learning themes related attentiveness, positive attitude, joyfulness, caring, gratefulness, obedience, patience, responsibility, self-control, creativity, honesty, wisdom, and includes a learning page portion 110, which is enable the learning of the steps of each learning theme, having a first step of ‘Thinking time’ page 111, a second step of ‘Story time’ page 112, a third step of ‘Imagine time’ page 113, a fourth step of ‘Action time’ page 114, a fifth step of ‘Build-up time’ page 115, a sixth step of ‘Sharing time’ page 116 and a seventh step of a Repetitive education page 117; an auxiliary learning page portion 120, which is assist the class the learning page portion 110, having a theme definition learning page 121, a Ruah theme song learning page 122, a Ruah rule learning page 123, a theme chant learning page 124, a theme story learning page 125, a theme game board page 126, a sticker page 127, a picture card page 128; a cover page portion 130 for accommodating the learning page portion 110 and the auxiliary learning page portion 120 are accommodated; and an opening hold cover portion 140 configured to accommodate or attach the cover page portion 130 selectively and to maintain the unfolded state of the corresponding pages during the learning.

That is, the learning study book 100 of the seventh step of the Ruah education of the present invention can help the learner's learning by configuring an opening hold cover portion 140 to accommodate the cover page portion 130 in a state in which the learning page portion 110 and the auxiliary learning page portion 120 for the learning theme are arranged in the cover page portion 130 and bound in a single book.

Here, since the learning page unit 110 and the auxiliary page unit 120 have the same configuration as described above, the detailed description thereof will be omitted. Also, since the cover page unit 130 also has the structure of the cover sheet of the known book structure, the detailed description thereof will be omitted.

The opening hold cover portion 140 includes an adhesive band 141, configured on the outer surface of the cover page portion 130, and formed a predetermined length corresponding to both lengths of the cover page portion 130 in the unfolded state and closely adhere the outer surface of the cover page portion 130 as means for allowing the learner to concentrate on the learning so that the expanded state of the pages is stably maintained; a folding preventing rolling bar 142, which is configured to be able to bend or roll with a predetermined length on both side portions of the center of the adhesive band 141, for stably maintaining the unfolded state of the pages when folded or rolled toward the outer surface of both sides of the center of the cover page 130; a bookmarking rolling bar 143, which is configured to be folded or rolled while having a predetermined length at both ends of the adhesive band 141, for providing a bookmarking function for the learned page by covering the edges of the pages when folded or rolled toward the inner surface of the edge portion of the cover page portion 130; and an anti-rolling bar 144, formed in the portion of the adhesive band 141 between the folding preventing rolling bar 142 and the bookmarking rolling bar 143, for stably maintaining the unfolded state of the pages by preventing the portion of the adhesive band 141 between the folding preventing rolling bar 142 and the bookmarking rolling bar 143 from rolling during rolling of the folding preventing rolling bar 142.

The adhesive band 141 may have a band structure of a synthetic resin material with a predetermined width and length. Preferably, it is adhered to the outer surface of the cover sheet 130 through the known adhesive structure.

The folding preventing rolling bar 142 and the bookmarking rolling bar 143 maintain the bar shape when the thin metal plate and one surface of the resilient metal plate have a concave surface in the longitudinal direction. On the other hand, when the other surface of the resilient metal plate has a convex structure, it has the characteristic of rolling like a hand-held blade or maintaining a shape bent at a predetermined angle.

The anti-rolling bar 144 is preferably a synthetic resin plate having a shape of the thin rod and the elasticity not to be rolled.

Here, it is preferable that the folding preventing rolling bar 142 has a length of about ¼ to 2/4 of the length of the width of the cover page portion 130 in the folded state.

Thus, according to the opening hold cover portion 140, when the textbook is spread on both sides, the force which is bent or rolled is applied only about ¼ to 2/4 the length of both sides of the center of the pages spread on both sides by the rolling of the folding preventing rolling bar 142. The both edge portions of the pages are not applied to the force of being rolled by the anti-rolling bar bars 144. At this time, the bookmarking function is provided on the page being studied when the bookmarking rolling bar 143 is rolled toward the upper edge of the pages. The current page being studied may not be folded or covered and a stable unfolded state may be maintained.

Therefore, when forming the opening hold cover portion 140 on the cover page portion 130 of the textbook, it is possible to reduce the hassle of having the learner unfold the page that was being re-learning to prevented from covering the page unfolded by the resilience of the pages could not be maintained due to the large number of pages of the textbook for the thickness of the textbook, thereby enabling the learning concentration to maximize the learning effect.

Although the present invention has been described with reference to the specific embodiments, various modifications may be made without departing from the scope of the present invention. Accordingly, the scope of the invention is not to be determined by the embodiments described, but should be determined by equivalents of the claims and the claims.

In addition, letters and sentences other than the drawings shown in the drawings of the present invention are intended to support specific contents for carrying out the present invention, and they are not included in the scope of the invention because they do not have any meaning or characteristic.

What is claimed is:

1. A seven steps learning study book of Ruah education comprising:
a plurality of volumes having twelve learning themes related attentiveness, positive attitude, joyfulness, caring, gratefulness, obedience, patience, responsibility, self-control, creativity, honesty, wisdom;
wherein the each volume of the learning theme divided into ‘open step’, ‘step 1’, and ‘step 2’, which enables selective learning corresponding to the age of the learner,
wherein the each volume of the learning theme includes a first step of Thinking time page 111, a second step of Story time page 112, a third step of Imagine time page 113, a fourth step of Action time page 114, a fifth step of Build-up time page 115, a sixth step of Sharing time page 116, and a seventh step of a Repetitive education page 117.

2. The seven steps learning study book of Ruah education according to claim 1, wherein the Thinking time page 111 comprises an area where a guidance sentence is described so that the learner may express a definition of the learning theme in songs and motions, recognize the definition of the learning theme through plays or games, learn meaning and sound of the definition or a main subject of the learning theme through old saying, and express and learn the old saying through the songs and chants,
the definition of the learning theme is expressed by the songs and the motions,
the definition of the learning theme is expressed by writing words or drawing pictures in hands in the corresponding area according to the guidance sentence or an instruction of a teacher,
the main subject of the learning theme comprises old saying which is short but meaningful sentence and reveal the definition of the learning theme, and the learner attaches or detaches stickers matching to corresponding letters after learning the meaning and sound of the old saying, and
the main subject of the learning theme by expressing the main subject of the learning theme in the songs and motions (or body).

3. The seven steps learning study book of Ruah education according to claim 2, wherein the second step of Story time page 112 comprising: an area where a guidance sentence is described so that the learner and a teacher read the Ruah story about the learning theme and recognize the contents through questions, and
the ‘Story time’ page 112 is processed by a Ruah reading method, and the Ruah reading method includes step 1 of reading the Ruah story and acting motions along with rhythm by the teacher, step 2 of allowing the learner to read the Ruah story and act the motions along with the rhythm taught by the teacher, step 3 of recognizing the content of the Ruah story through questioning and discussing, and step 4 of reading the Ruah story repeatedly by a group of three learners.

4. The seven steps learning study book of Ruah education according to claim 3, wherein the third step of the Imagine time page 113 comprising: an area where a guidance sentence is described to develop creative thinking through various imaginings through asking questions and discussions after reading the Ruah story of the learning theme, and
the learners may write letters or draw pictures in the corresponding area according to a teacher's questions or guidance sentence, and freely imagine or present their answers by the learner.

5. The seven steps learning study book of Ruah education according to claim 4, wherein the fourth step of the Action time page 114 comprising: an area where a guidance sentence is described to make a decision what they realize and practice in action through the self-reflection after reading the Ruah story on the learning theme,
the learners can write letters or draw pictures in the corresponding area according to the teacher's question or the guidance sentence, and present their decisions.

6. The seven steps learning study book of Ruah education according to claim 5, wherein the fifth step of Build-up time page 115 comprising: an area where a guidance sentence is described to expand what they know by presenting in front of their parents and family at home what they learned in the Ruah story and the contents learned in all steps,
the ‘Build-up time’ page 115 is proceeded through a build-up step, which comprising: a first step of summarizing and talking, a second step of talking what they learned through the Ruah story, and the three step of talking my decision.
Also, the ‘Build-up time’ page 115 provides an area to present in front of their parents and family about the Ruah story using picture materials related to the learning theme, and the learner use the picture material as a tool or material necessary for the presentation by cutting out or pasting the picture material onto the area.

7. The seven steps learning study book of Ruah education according to claim 6, wherein the sixth step of Sharing time page 116 comprising: an area in which the guidance sentence is described so that the parent write the contents of their child's presentations and impressions in the corresponding area to forward the teacher,
the ‘Sharing time’ page 116 is divided into a first part of writing the Ruah story as the parent listen to their child's presentation, a second part of questioning and selectively answering by dividing attentiveness, asking questions, praising, and encouraging for the parents' responses when their child presents the Ruah story, and a third part of writing the parent's impression.

8. The seven steps learning study book of Ruah education according to claim 7, wherein the seventh step of Repetitive education page 117 comprising: an area where a guidance sentence is described to read the Ruah story repeatedly through the group activities of the three members explained in fourth step of the Ruah reading method, and to practice good thinking, good feeling, and good action.

9. The seven steps learning study book of Ruah education according to claim 1, further comprising:
a theme definition learning page 121 for learning a definition of the learning theme;
a Ruah theme song learning page 122 for learning the theme song for the Ruah learning;
a Ruah rule learning page 123 for learning the rules of Ruah learning;
a theme chant learning page 124 for learning old saying and songs for the learning theme;
a theme story learning page 125 in which the learner and the teacher learn for imagining or freely talking a story based on illustrations of the learning theme;
a theme game board page 126 for allowing the learners to practice the attitude of the learning theme while playing a game with friends through the game after the all steps learned for the learning theme; and
a picture card page 128 that is used as an auxiliary tool, and meaning, and the contents of the old saying about the main subject of the learning theme needed during the ‘Thinking time’ page are described on the one side and the other side of the sound.

10. The seven steps learning study book of Ruah education according to claim 9, further comprises a sticker page 127 for stimulating learning curiosity, since the stickers corresponding to the main subject of the learning theme or the Ruah story needed in ‘Thinking time’ and ‘Story time’ steps during learning about the learning theme is attachable or detachable.

11. The seven steps learning study book of Ruah education according to claim 9, wherein the theme definition learning page 121 comprises an area in which the guidance sentence for learning the definition and motion of the learning theme is described, a first part for describing a dictionary meaning or expression for the definition of the learning theme, and a second part, in which pictures are described to express, for describing the definition of the theme of the learning to be expressed by a motion.

12. The seven steps learning study book of Ruah education according to claim 9, wherein the Ruah theme song learning page 122 comprises an area where alyrics is written so that the teacher and the learners can sing the theme song of the Ruah learning themes.

13. The seven steps learning study book of Ruah education according to claim 9, wherein the Ruah rules learning page 123 comprises an area where the rule is described so that the teacher and the learners repeatedly shout slogans daily to learn.

14. The seven steps learning study book of Ruah education according to claim 9, wherein the theme chant learning page 124 comprises an area where the old saying and song about the main subject of the learning theme to be learned is described, a first part where the old saying and the meaning of the main subject of the learning theme are described, and a second part where the lyrics for describing the main theme of the learning theme is described, and allows the learners to learn the main subject and the theme song of the learning theme according to the teacher's teachings.

15. The seven steps learning study book of Ruah education according to claim 9, wherein the theme story learning page 125 comprises an area in which a guide picture is described to allow the teacher and the learners to visually understand the contents when the Ruah story about the learning theme is conducted by the Ruah reading method, a first part where illustrations are drawn to allow the learner to visually see the contents of the Ruah story when the Ruah story is carried out by the Ruah reading method, and a second part where a QR code is printed so that the Ruah story according to the Ruah reading method is reproduced by a song and a video.

16. The seven steps learning study book of Ruah education according to claim 9, wherein the theme game board page 126 includes an area in which a guidance sentence is described to allow learners to practice their attitudes on the learning theme while playing fun with friends and playing games after learning in all steps for the learning theme, a part where a game rule and a game board are drawn, so that learners and friends move a dice and a gaming horse as many as the number of the dice to perform a mission guided to the part where the horse is located.

17. The seven steps learning study book of Ruah education according to claim 10, wherein the sticker page 127 is configured such that the sticker is attachable or detachable, where the sticker is corresponding to the main subject of the learning theme or the Ruah story required in the ‘Thinking time’ and ‘Story time’ steps of learning study for the learning theme, and the sticker page 127 includes a first part where the sticker necessary for the step of the learning theme is detachably adhered, and a second part where the page number of the step to which the sticker is to be adhered.

18. The seven steps learning study book of Ruah education according to claim 9, wherein the picture card page 128 is configured such that the picture card is attachable or detachable where the picture card is used as an auxiliary tool and the sound, the meaning, and the contents of the old saying about the main subject of the learning theme, that is needed during the ‘Thinking time’ step of learning about the learning theme, are written on one side and the other side of the picture card, and
the picture card page 128 may have a structure in which the picture card is cut or taken off, and Chinese character of the old saying and the meanings and sound for each Chinese character are described in one side of the picture card page, while pronunciations and its meaning for each Chinese character of the old saying are described the other side.

19. A seven steps learning study book of Ruah education comprising:
a plurality of volumes having twelve learning themes related attentiveness, positive attitude, joyfulness, caring, gratefulness, obedience, patience, responsibility, self-control, creativity, honesty, wisdom:
wherein the each volume of the learning theme includes a learning page portion 110, which is enable the learning of the steps of each learning theme, having a first step of ‘Thinking time’ page 111, a second step of ‘Story time’ page 112, a third step of ‘Imagine time’ page 113, a fourth step of ‘Action time’ page 114, a fifth step of ‘Build-up time’ page 115, a sixth step of ‘Sharing time’ page 116 and a seventh step of a Repetitive education page 117;
an auxiliary learning page portion 120, which is assist the class the learning page portion 110, having a theme definition learning page 121, a Ruah theme song learning page 122, a Ruah rule learning page 123, a theme chant learning page 124, a theme story learning page 125, a theme game board page 126, a sticker page 127, a picture card page 128;
a cover page portion 130 for accommodating the learning page portion 110 and the auxiliary learning page portion 120 are accommodated; and
an opening hold cover portion 140 configured to accommodate or attach the cover page portion 130 selectively and to maintain the unfolded state of the corresponding pages during the learning.

20. The seven steps learning study book of Ruah education according to claim 19, wherein the opening hold cover portion 140 comprising:
an adhesive band 141, configured on the outer surface of the cover page portion 130, and formed a predetermined length corresponding to both lengths of the cover page portion 130 in the unfolded state and closely adhere the outer surface of the cover page portion 130 as means for allowing the learner to concentrate on the learning so that the expanded state of the pages is stably maintained;
a folding preventing rolling bar 142, which is configured to be able to bend or roll with a predetermined length on both side portions of the center of the adhesive band 141, for stably maintaining the unfolded state of the pages when folded or rolled toward the outer surface of both sides of the center of the cover page 130;
a bookmarking rolling bar 143, which is configured to be folded or rolled while having a predetermined length at both ends of the adhesive band 141, for providing a bookmarking function for the learned page by covering the edges of the pages when folded or rolled toward the inner surface of the edge portion of the cover page portion 130; and
an anti-rolling bar 144, formed in the portion of the adhesive band 141 between the folding preventing rolling bar 142 and the bookmarking rolling bar 143, for stably maintaining the unfolded state of the pages by preventing the portion of the adhesive band 141 between the folding preventing rolling bar 142 and the bookmarking rolling bar 143 from rolling during rolling of the folding preventing rolling bar 142.
